(19) United States
(12) Patent Application Publication
(10) Pub. No.: US 2002/0104389 A1
(43) Pub. Date: Aug. 8, 2002

(54) Automated liquid handling device

(76) Inventor: Scott A. Hovey, Alton, IL (US)

Correspondence Address: Don W. Weber, 212 East Main Street, Collinsville, IL, 62234, US

(21) Appl. No.: 09/779,006

(22) Filed: Feb. 8, 2001

(51) Int. Cl. G01N 1/14; B32B 27/04

(52) U.S. Cl. 73/864.17; 73/863.32; 422/100

(57) ABSTRACT

An improvement on the standard bi-directional liquid sample handling system mechanism is provided. The improvement comprises a mechanism for sealing 24 pipettes arranged in a row. When the industry went from 12 wells to 24 wells, the construction of the pipettes, plungers and seals and the means for locating the pipettes had to be changed. This improvement comprises stainless steel plungers and pipettes that are much smaller in diameter, as well as an external sealing mechanism comprising an O-ring, a flange, and a biasing spring. Another improvement comprises replacing the rack-and-pinion table drive mechanism with a belt and pulley mechanism for more precisely locating the 24 pipettes over the corresponding 24 microtitre wells.

### BACKGROUND OF THE INVENTION

This device relates to the field of medical instruments. More particularly, a device is presented which transfers liquid through twenty-four pipettes onto a microtitre tray..

Particularly in the medical research field, it is often necessary to transfer liquid in small quantities into wells located on a microtitre sample tray. There are three primary protocols used in this process. They are serial dilution, plate filling and plate-to-plate transfer.

The serial dilution protocol provides for mixing a sample with successively increasing proportions of a dilutant in separate wells of a small microplate. The standard microplate currently in use is a 384 well microplate. Mixing the sample results in a series of successively decreased concentration of a sample. For example, the sample may be an antibiotic successively diluted in a solution containing known bacteria. By measuring the lack of growth of the bacteria based upon the concentration of the antibiotic, the result can be measured to determine the minimum concentration of the antibiotic required to inhibit bacterial growth, called the minimal inhibitorial concentration or MIC. There are countless other examples of how the serial dilution protocol is used in research and development, quality control and drug discovery laboratories.

The plate filling protocol provides for the transfer of liquid from a vessel to a 384 well microtitre plate. Liquids are aspirated into disposable pipette tips from a container of suitable capacity for the protocol desired. The sample is aspirated out of these bulk reagent containers and transferred to the microtitre plate in volumes from 1 to 50 microliters. For example, the plate filling protocol would be used to transfer 50 microliters of diluent into the microtitre plate in preparation for a subsequent protocol such as the serial dilution illustrated above.

The plate-to-plate (also known as mother-daughter plate) transfer provides for transfer of liquids from one or more rows of the sample (mother) plate to one or more rows of the target (daughter) plate. For example, utilizing the 24 channel liquid head of the instant device, the 24 samples in Row A of the sample or mother plate are transferred to Row A of the target or daughter plate. The samples in Row B from the Mother plate are then transferred to Row B of the daughter plate and so on through Row P (Row 16) when all 384 wells have been transferred. Computer software, which is well-known in the art, allows for variations on this protocol to provide for transferring from one to several rows if desired. The very common use for this protocol is replicating a master mother plate into many daughter plates for testing different compounds for drug discovery.

Initially, the transfer functions were performed manually using a syringe or pipette. Subsequently, machines were developed for automating this process, one example of which is disclosed in the 1985 U.S. Pat. No. 4,555,957, issued to Frankel, et al.

The development of these liquid transfer machines has kept pace with the standard use in the industry. One such machine, using a single pipette that traveled along a horizontal direction to fill microtitre trays is found in the 1985 patent issued to Frankel, et al. and assigned to the Cetus Corporation. In this patent, a single pipette was used to fill the standard microtitre trays. During that stage of the development of microtitre trays, the trays that were in standard use in the industry had twelve receptacles, or wells, in a row, and usually had eight rows of receptacles. This standard tray is approximately 4.58 inches in width. The '957 patent of Frankel had a single pipette 84 attached to an actuator bar 46. The single pipette moved horizontally across the rows of 12 wells to fill each in succession. This single pipette and actuator bar are best shown on FIG. 3 of the '957 patent.

A further innovation in this particular field is found in the 1984 U.S. Pat. No. 4,478,094. This patent was also assigned to the Cetus Corporation. In this patent, however, a row of 12 pipettes were used. These 12 pipettes, as best shown in FIG. 8 of the '094 patent, were spatially arranged to correspond to the row of twelve wells in the standard microtitre plate. Rather than having a head move across the twelve wells in the row, the twelve pipettes of the '094 patent simultaneously filled the twelve wells according to the specifications of the fluid to be dispensed.

A common element of both the '957 and '094 patents is the size and construction of the actual pipette. The standard pipette is shown in FIG. 5 of the '957 patent, and FIG. 3 of the '094 patent. This standard pipette, as illustratively shown in FIG. 3 of the '094 patent, utilized a compliant spring 45, a grommet 47, and an O-ring 49. The particular construction of this pipette, constrained only by the geometric location of the corresponding twelve wells beneath each pipette tip, allowed the O-ring 49 to be inserted within the pipette walls and held in place by the grommet 47 and the compliant spring 45. Because of the size of the microtitre tray, being approximately 4.58 inches in width and containing twelve wells, there was sufficient space to countersink the upper portion of the pipette and to insert the spring, grommet and O-ring, while not compromising the strength of the upper pipette walls.

New standards in the industry have developed since the '957 and '094 patents were introduced. These new standards included a microtitre tray which was still approximately 4.58 inches in width, but which now has 24 wells in each row. The standard microtitre tray was also expanded to have sixteen rather than eight rows, so that the new microtitre trays now contain 384 wells arranged in twenty four rows and sixteen files, rather than 96 wells, arranged in twelve rows and eight files. However, this new standard tray created problems for the delivery systems previously known in the art. It is an object of this invention to provide an automatic liquid handling system, which accommodates the new 24 by 16 microtitre trays.

The main problem encountered in expanding the pipette count from 12 to 24 in each row is the physical limitation of the space available. While the microtitre tray did not increase its width by any substantial margin, the necessity of having 24 wells in a row rather than 12 created smaller wells, which had their radii closer together. This, in turn, meant that the pipettes themselves had to be reduced in diameter to fit the corresponding geometry of the microtitre wells. However, the standard Teflon pipettes would no longer accommodate the compliant spring, grommet and O-ring as shown in the '957 and '094 patents.

Another method had to be devised to seal the pipettes while still maintaining the integrity of the upper pipette sides. Experimentation with the old method of inserting the spring, grommet and O-ring inside the pipette ended in failure because of the reduced strength of the pipette walls due to the reduced space available. It is another object of this invention to provide a seal for a pipette in a series of 24 pipettes corresponding to the standard microtitre trays which does not compromise the strength of the upper walls of the pipette.

In order to solve this problem, numerous different methods were tried. However, the solution to this problem lay in the discovery that the pipettes could be effectively sealed using an O-ring seal at the upper surface of the pipette. This O-ring seal could then be appropriately tightened by other mechanisms. It is a still further object of this invention to provide a seal for a series of 24 closely arranged pipettes using external mechanisms.

Another problem with the prior art delivery systems is that they used a rack-and-pinion system in order to move the tray table. It has been found that such a rack-and-pinion drive system sometimes does not allow for the close tolerances of the very compact 384 well microtitre tray. In order to improve the accuracy of the placement of each microtitre well, a belt drive mechanism has been added to this invention to replace the rack-and-pinion mechanism. This belt drive mechanism makes the exact placement of the microtitre wells possible. It is a still further object of this invention to provide an improved drive system for the microtitre tray table in liquid transfer systems to enable exact placement of each microtitre well.

Other and further objects of this invention will become apparent upon reading the below described Specification.

### BRIEF DESCRIPTION OF THE INVENTION

This invention is an improvement on the prior art involving the bi-directional liquid sample handling systems found in earlier patents. The earlier patents provided for one or twelve pipettes arranged in a horizontal row. Because of size restraints, the pipette in the twenty four pipette device has to be sealed by the use of an upper O-ring compressed by a flange and held in place by a biasing spring. This external mechanism eliminates the need to countersink the upper sides of the pipette and does not compromise the strength of the upper portion of the pipette. By utilizing the external sealing mechanism described above, 24 pipettes can be arranged in a row and still be within the width dimensions of the standard microtitre trays. A belt drive also replaces the rack-and-pinion method of moving the tray, allowing for greater precision in the positioning of the tray.

### BRIEF DESCRIPTION OF THE DRAWING FIGURES

FIG. 1 is a perspective view of the liquid sample handling system.

FIG. 2 is a front view of the delivery system, showing the 24 pipettes and the functional mechanisms.

FIG. 3 is a partial cutaway view of the right side of the delivery mechanism shown in FIG. 2.

FIG. 4 is an exploded view of FIG. 3.

FIG. 5 is a top, partial cutaway, view of the entire device shown in FIG. 1.

FIG. 6 is a side, partial cutaway, view of the entire device shown in FIG. 5.

### DETAILED DESCRIPTION OF THE PREFERRED EMBODIMENT

A 24 channel automated liquid handling device is shown in FIG. 1. This device includes a housing 2 containing the motors and electronics used to drive and direct the various mechanism. Attached to the housing 2 is a stationary platform 2′.

The stationary platform 2′ supports a horizontally translatable table 3. This table slides back and forth under the pipette nozzles as directed by a programmable computer. The horizontally translatable table 3 slides in platform grooves 4.

The translatable table 3 supports individual 384 well microtitre plates 5. These microliter plates are now standard in the industry, the 24 row by 16 files trays having replaced the 12 row by 8 file trays, which were the earlier standard in the industry. The new 384 well microtitre plates greatly enhance the efficiency of this particular art. The microtitre plates move with the movement of the translatable table 3 so that the other mechanisms may dispense or aspirate liquid into specified wells as desired.

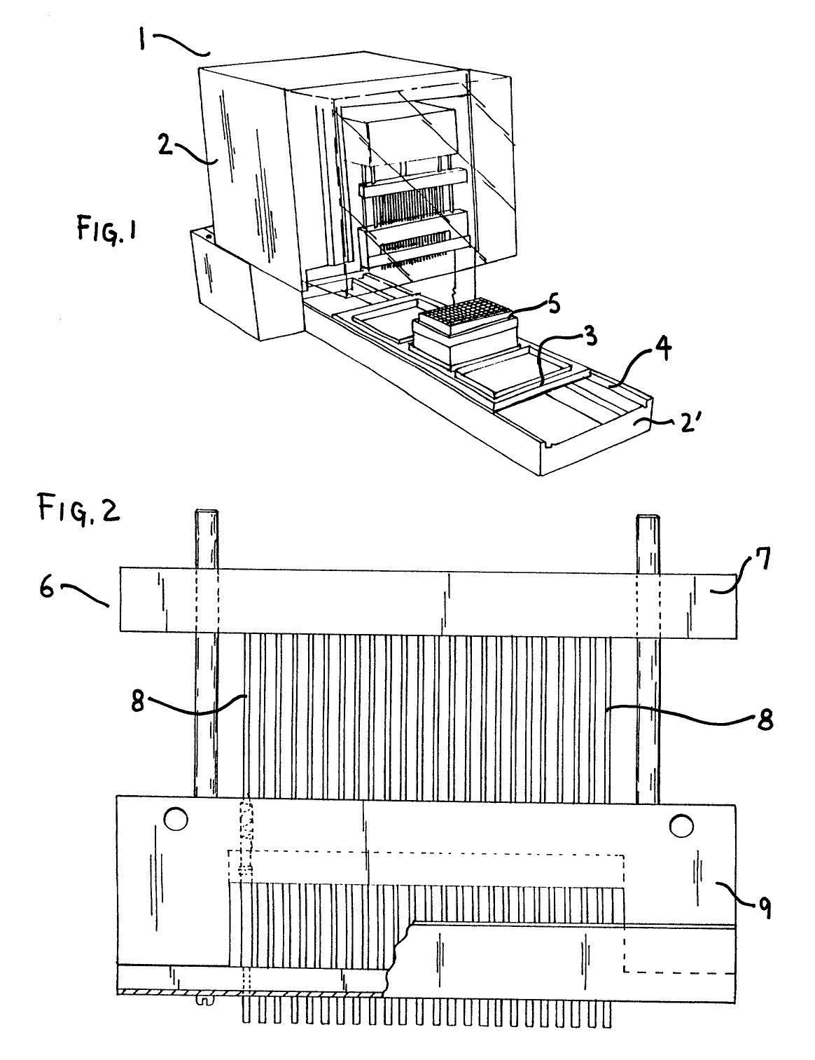

Turning now to FIG. 2, the 24 pipette dispensing mechanism is particularly illustrated. The liquid head assembly 6 comprises a plunger yoke 7 which is a stainless steel bar with 24 stainless steel solid pistons 8 arranged vertically, as shown. These 24 stainless steel solid pistons 8 relative to the lower 24 way block 9 when the block is moved up and down. The precise construction and movement of these steel rods has been adequately disclosed in the prior art, particularly in the '094 and '957 patents. The movement of these piston rods is essentially the same as in the prior art.

However, the construction of the rods, pipettes and seals is decidedly different. Because of the limitations of the new microtitre trays (24 wells in a row rather than 12), the diameter of the stainless steel solid pistons had to be greatly reduced. The original pistons disclosed in the prior art were approximately 0.125 inches in diameter. The relatively large space allowed for these pistons due to the 12 well arrangement was greatly compacted when the industry added another 12 wells in each row. Consequently, the new stainless steel pistons 8 have a diameter of approximately 0.079 inches to 0.080 inches. This smaller diameter piston was made necessary by the change in the industry.

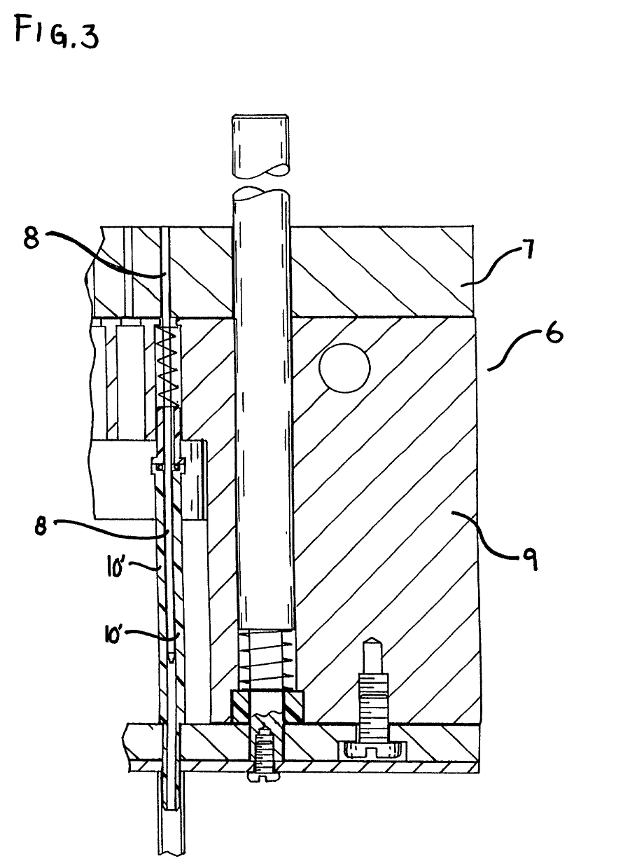

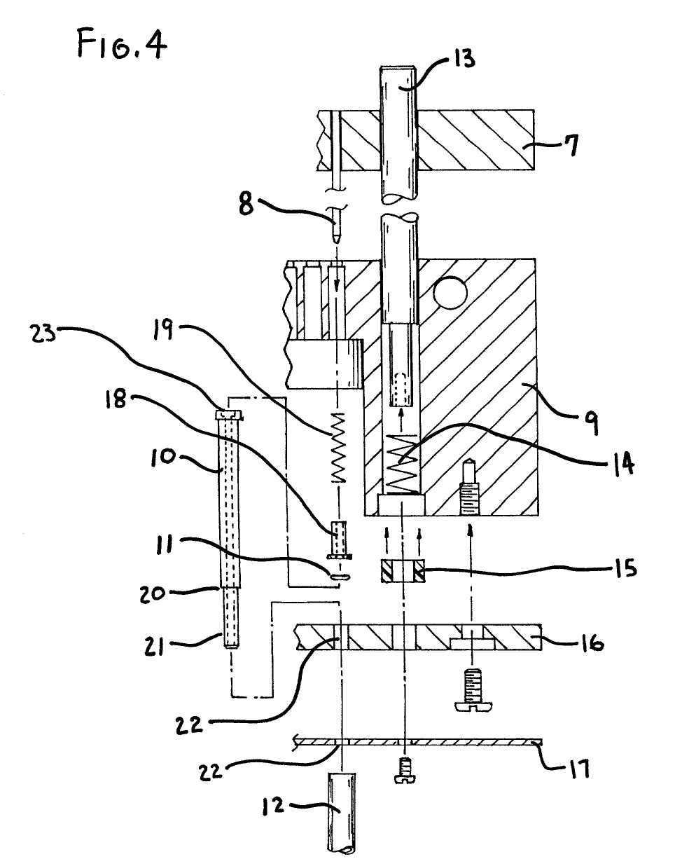

Turning now to FIGS. 3 and 4, the new design for the pipette and piston mechanism is disclosed. Because there are now 24 wells in each row rather than 12, the size of the stainless steel pistons had to be reduced. In addition, the diameter of the plunger housing (pipette) 10 also had to be greatly reduced due to the spatial limitations. Reducing the diameter of the plunger housing 10 meant that the thickness of the upper plunger housing walls 10′ also had to be greatly reduced. This greatly reduced upper wall thickness 10′ necessitated that the O-ring seal, the O-ring flange and the flange biasing spring had to be removed from the inside of the plunger housing 10. After much experimentation, the alternate seal shown in FIG. 4 was discovered.

In order to provide for an effective seal for the pipette or plunger housing 10, the external means disclosed herein was devised. In the current device, the upper surface 23 of the plunger housing 10 supports an elastic O-ring 11. This elastic O-ring is much more pliable than the previously used internal lip seal. In order to compress the O-ring 11 onto the upper surface 23 of the plunger housing 10, an O-ring flange 18 is used. The O-ring flange 18 is biased downwardly by the flange biasing spring 19. This flange biasing spring 19 is held in place as shown by the retaining wall on FIG. 4. The entire sealing mechanism, including the O-ring 11, the flange 18 and the spring 19, is now external to the body of the upper plunger housing 10.

As in the previous designs for this machine, a number of disposable pipettes 12 are attached to the pipette tip 21. The 24 stainless steel solid pistons 8 are actuated in a relative up and down direction by the plunger assembly piston 13. The plunger assembly piston 13 is biased upwardly by the plunger assembly piston biasing spring 14. The plunger biasing spring 14 is held in place by the plunger assembly spacer 15. A lower 24 way block bottom plate 16 is attached to the lower 24 way block 9 by means of the screws shown in FIG. 4. Attached at the very bottom of the 24 way block bottom plate 16 is a cover plate 17, attached by screws. It is to be appreciated that the plunger assembly, including the piston, spring, spacer, plate and cover is one means to drive the stainless steel solid pistons 8 up and down, relatively. However, this particular configuration is meant as an illustration only and not as a limitation to this invention. This method of driving the pistons has been fully disclosed in prior patents and is not considered to be part of the invention described herein.

The pipette 10 is inserted through the pipette orifice 22 such that the tip 21 protrudes beneath the 24 way block cover plate 17. The pipette 10 has a shoulder 20 which rests on the upper portion of the block bottom plate 16 with the tip protruding beneath the block cover plate 17. This protruding tip 21 is inserted into disposable pipette tips 12 by means previously described in the prior art patents and disclosed briefly below.

Disclosed in the prior art, but not shown in the present drawings, is a plunger motor assembly. The plunger motor assembly includes a stepper motor and a lead screw for driving the plunger assembly.

As previously disclosed in the prior art, the liquid head assembly is positioned over a corresponding row of wells in a microtitre tray by means of software which controls the head motor driver assembly and the plunger motor assembly. Precise positioning utilizes two Hall effect sensors and corresponding trigger flags. The precision of dispensing is further enhanced by software control that allows the slope to be adjusted to compensate for minor differences in the machining of lead screws, super nuts and the like. Tolerances can be compensated for in the software to provide for the precision of movement necessary to transfer a volume of liquid as minute as one microliter with exceptional accuracy.

As disclosed in the prior art, this instrument is controlled by microprocessors utilizing standard protocols stored in EPROM memory that can be used or modified by the operator to customize their test protocols. The electronics consist of a mother board PCB assembly, a central processing unit PCB assembly, two motor driver PCB assemblies for driving the stepper motors, a hand controller PCB keypad assembly for controlling the instrument and associated power supplies and connecting mechanisms. These sensors and microprocessors are well-known in the art and have been utilized in the sample handling industry for a number of years.

In operation, the microprocessor and sensors position the 24 pipettes in exact corresponding alignment above 24 disposable pipettes arranged in a row. The head motor drives the head down to pick up the tips and then drives the head upward so that the retained tips will clear the tip rack.

In the prior art, the rack-and-pinion drive, and in the current device, a pulley-and-belt mechanism, then moves the liquid head assembly 6 such that the disposable tips are near the corresponding lower microtitre wells. Once the tips are placed near the pickup microtitre wells, the plunger 24 way block 9 is moved downward (as shown in FIG. 2). This downward motion of the block 9 moves the plunger housing (pipette) 10 downward, moving the stainless steel solid pistons 8 upward relative to the plunger housing 10. This relative upward motion of the solid pistons 8 creates a vacuum within the tightly sealed plunger housing 10 aspirating liquid into the disposable tip 12.

Once the liquid has been aspirated into the disposable tips, the head motor drives the head up over the pickup plate. The head 6 is then positioned by the sensors and microprocessors over a second discharge tray containing 24 discharge wells located directly above the corresponding 24 pipettes. The plunger motor then drives the 24 way block 9 up, as shown in FIG. 3. This upward movement of the lower block 9 corresponds to a downward relative movement of the solid pistons 8. This, in turn, dispenses the liquid into the 24 corresponding discharge wells.

Once the liquid has been picked up and discharged, as described above, the head motor drives the dispensing head up and the table motor then moves the table so that the disposable tips may be ejected in an appropriate manner by the plunger motor. The tips are then ejected and the entire cycle begins again.

This brief description of the function of the machine is provided as an illustration only. The precise functioning of this machine has been well described in the prior art patents previously cited. However, none of the prior art patents disclosed a mechanical structure and design capable of providing for 24 very small pipettes with very small plungers for use with a corresponding 24 well microtitre tray.

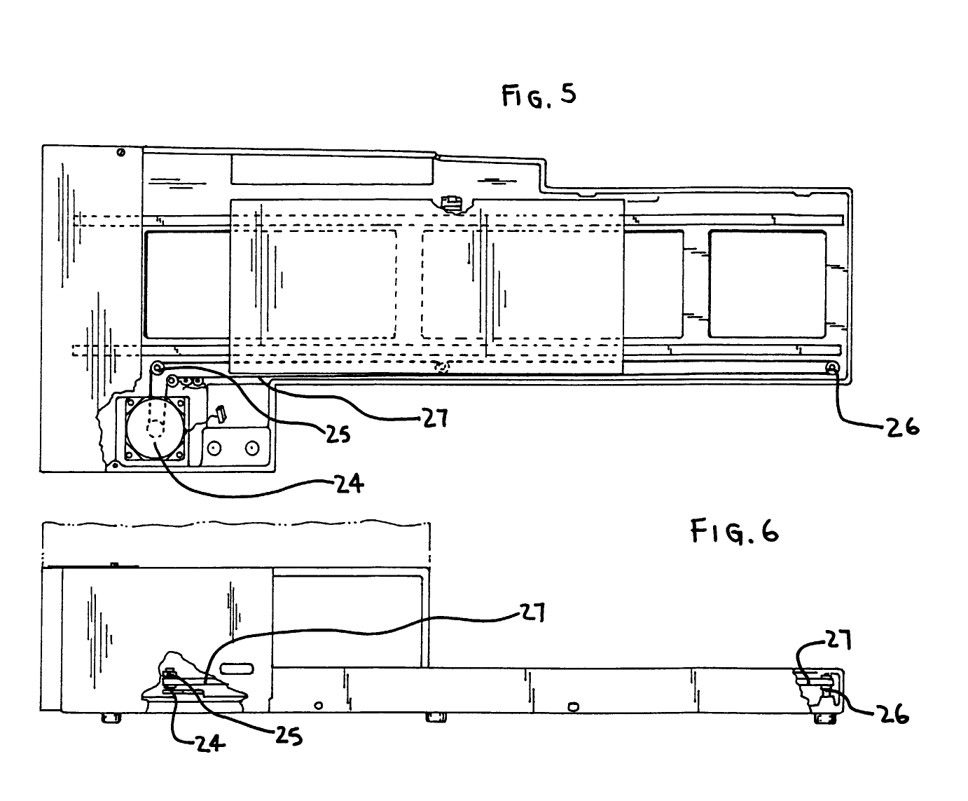

Turning now to FIGS. 5 and 6, one further significant improvement to the prior art liquid handling devices is disclosed. This further improvement comprises replacing the prior art rack-and-pinion table drive to a belt-and-pulley drive. In the instant device, a table drive pulley 24 is attached to the table motor. This table drive pulley 24 is attached through a belt 27 to a table reducing pulley 25. This table reducing pulley 25 is in turn attached to the table end pulley 26 by the belt 27. When the table motor is moved by the microprocessor and controlled by the sensors, the table 3 slides along the table grooves 4 to an exactly positioned location directly below the corresponding 24 disposable pipettes. By using the pulleys 24, 25 and 26 and the belt 27, the horizontally translatable table 3, and consequently the 384 well microtitre plate 5, can be exactly positioned. This is an improvement over the unprecise rack-and-pinion drive system of pipette devices in the prior art. The improved pulley-and-belt system was required by the physical changes to the microtitre plate involving 24 wells instead of twelve wells within a 4.58 inch width. The increased number of wells required more precise positioning because the diameter of each well was greatly reduced.

While the bulk of this particular device is well-known in the prior art, and has been in common use for many years, the new innovations presented herein solved problems which are unique to the sample handling field. Because of the greatly reduced size of the microtitre wells, smaller pistons and smaller plunger housings were required. In order to maintain the strength of the plunger housings, a new mechanism had to be devised to both seal the plunger housing and to allow for its side wall strength. In addition, the older rack-and-pinion method of positioning the pipette tips over the microtitre wells had to be improved to provide for closer tolerances.

Having fully described my invention, I claim:

1: In a liquid handling system comprising a plurality of pistons which aspirate and dispense sample liquid into and from a plurality of pipettes, the improvement comprising an external sealing mechanism, said external sealing mechanism comprising:
(a) an O-ring disposed on the upper surface of the pipette,
(b) an O-ring flange disposed on top of said O-ring; and
(c) a flange biasing spring, which biases said flange, O-ring and pipette upper surface together to form a tight seal.

2: In a liquid handling system comprising a plurality of pistons which aspirate and dispense sample liquid into and from a plurality of pipettes as in claim 1, wherein 24 pipettes are arranged in a row, whereby the lower tips of said pipettes may be located directly above corresponding 24 wells of a 384 microtitre tray.

3: In a liquid handling system wherein a 24 row by 16 file microtitre plate must be positioned precisely above a corresponding 24 row pipette head, the improvement comprising a pulley-and-belt means for positioning said plate precisely with respect to said 24 row pipette head.
